(19) United States
(12) Patent Application Publication
(10) Pub. No.: US 2018/0286366 A1
(43) Pub. Date: Oct. 4, 2018

(54) SOUND/VIDEO GENERATION SYSTEM

(71) Applicant: DMET PRODUCTS CORP., Tokyo (JP)

(72) Inventors: Masaki OGURO, Tokyo (JP); Daigo KUSUNOKI, Tokyo (JP); Shogo TAKEDA, Tokyo (JP); Hideaki SAGO, Tokyo (JP)

(73) Assignee: DMET PRODUCTS CORP., Tokyo (JP)

(21) Appl. No.: 15/551,618

(22) PCT Filed: Oct. 14, 2016
(86) PCT No.: PCT/JP2016/080847

§ 371 Date: Aug. 17, 2017

(30) Foreign Application Priority Data
May 13, 2016 (JP) PCT/JP2016/064248

(51) Int. Cl. G10H 1/00

(52) U.S. Cl. CPC G10H 1/0008; G10H 1/0083; G10H 2220/005; G10H 2220/395; G10H 2220/391; G10H 2220/401

(57) ABSTRACT

It is provided a sound/video generation system, comprising: a mobile terminal including a motion detection unit and to be installed on a motion subject; and a sound/video generator including a communication unit coupled to the mobile terminal in a wireless manner, the mobile terminal including a calculation unit configured to add absolute values of magnitudes of data on a motion in directions of three axes substantially orthogonal to one another, which is detected by the motion detection unit, the sound/video generation system comprising a judgment unit configured to determine whether or not a predetermined amount of motion is detected based on a result of calculation by the calculation unit, the sound/video generator including a sound/video generation unit configured to generate at least one of a sound or a video in accordance with a result of determination by the judgment unit.

### BACKGROUND OF THE INVENTION

This invention relates to a sound/video generation system including: a mobile terminal including a motion detection unit and installed on a motion subject; and a sound/video generator including a communication unit coupled to the mobile terminal in a wireless manner. The sound/video generation system is configured to detect a motion of the motion subject, and reproduce at least one of a sound or a video set in advance or randomly reproduce at least one of the sound or the video.

Hitherto, there has been known a musical performance interface configured to analyze a vertical swinging motion, a horizontal swinging motion, an oblique swinging motion, a turning motion, and other motions based on, for example, a magnitude relationship among acceleration values in an X direction, a Y direction, and a Z direction of a mobile terminal including a motion detection unit and fixed to the body of a user or carried around with hands of the user. Such a musical performance interface is also configured to control the sound in order to primarily cause a sound to be played such as a slur and a staccato to express musicality based on the analyzed motions (see JP 2001-195059 A).

However, in this kind of interface, when a mobile terminal including a motion detection unit is fixed to, for example, an arm or a leg of a dancer, only a small amount of unintended motion generates a sound, which causes the dancer to become too sensitive to his or her motion. As a result, the dancer feels a lot of stress and cannot concentrate on dancing.

In other cases, regarding a musical performance interface to be used mainly for a toy, an average value of a large indefinite number of children needs to be adopted as a reference value for determining “whether or not to generate a sound”, and an age difference, a physical difference, and a muscle difference among children are not taken into consideration. As a result, some children produce sounds while others do not with the same motion. This means that children, namely, users cannot play with the toy until, for example, the users become proficient in how to move with the toy or learn to swing more strongly (see WO 2015/177835 A1).

Further, there is known a sound output control unit configured to calculate a stroke value by adding acceleration values in the X direction and the Z direction, and estimate a string action position in response to a change in stroke value satisfying a predetermined relationship with a plurality of threshold values set in advance, to thereby control sound output (see JP 2007-298598 A). Further, there is known a musical performance device in which a CPU of the musical performance device is configured to determine whether or not a sensor composite value, which is obtained by calculating a square root of the sum of squares of an X-axis component, a Y-axis component, and a Z-axis component of a first acceleration sensor value, is larger than a value corresponding to (1+a)×G, to thereby generate a sound (see JP 2012-18334 A). Further, there is known a musical performance device in which a stick part is configured to perform shot detection processing and action detection processing based on motion sensor information (see JP 2014-62949 A).

Further, in the related art, a mobile terminal including a motion detection unit is configured to transmit all the information of a motion detection sensor (e.g., acceleration, angular velocity, and geomagnetic value) to a sound generator, and a calculation unit in the sound generator is configured to perform determination of the information. In this case, transmission by a single or a small number of mobile terminals does not cause a problem in processing. However, for example, when a large number of dancers each wear mobile terminals including motion detection unit on both arms and both legs, and transmit motion detection sensor information all at once, the calculation unit in the sound generator cannot handle the processing.

### SUMMARY OF THE INVENTION

As described above, humans cannot intuitively recognize their own three-dimensional positions (X, Y, Z). Thus, a musical performance interface that is based on an algorithm constructed with the X direction, the Y direction, and the Z direction as a reference generates an unintentional sound. A human body or a motion subject containing the human body exhibits a unique motion, and thus a mobile terminal including a motion detection unit and fixed to the human body or the motion subject needs to adjust detection levels individually. When many mobile terminals including motion detection unit transmit sound generation requests at the same time, at most one sound generator needs to serve those requests.

Further, the sound output control device disclosed in JP 2007-298598 A controls sound output based on the value obtained by adding the acceleration values in two axes, namely, the X-axis direction and the Z-axis direction. This value represents the stroke value of a controller and is used to calculate the string action position, which means that detection of a degree of motion by the motion detection unit and generation of a sound are not intended.

Further, the musical performance device disclosed in JP 2012-18334 A generates a sound based on the sensor composite value, which is obtained by calculating the square root of the sum of squares of an X-axis component, a Y-axis component, and a Z-axis component of the acceleration sensor value. Similarly to JP 2001-195059 A described above, the sum of squares is used, and thus the amount of calculation is large and an unintentional sound may be generated.

Further, the musical performance device disclosed in JP 2014-62949 A performs shot detection processing and action detection processing based on motion sensor information, but how to process signals from an acceleration sensor is not specifically disclosed.

This invention has an object to solve the above-mentioned problems.

The representative one of inventions disclosed in this application is outlined as follows. There is provided a sound/video generation system, comprising: a mobile terminal including a motion detection unit and to be installed on a motion subject; and a sound/video generator including a communication unit coupled to the mobile terminal in a wireless manner. The mobile terminal including a calculation unit configured to add absolute values of magnitudes of data on a motion in directions of three axes substantially orthogonal to one another, which is detected by the motion detection unit. The sound/video generation system comprising a judgment unit configured to determine whether or not a predetermined amount of motion is detected based on a result of calculation by the calculation unit. The sound/video generator including a sound/video generation unit configured to generate at least one of a sound or a video in accordance with a result of determination by the judgment unit.

According to the one embodiment of this invention, it is possible to generate at least one of a sound or a video accurately in accordance with the detected motion.

### BRIEF DESCRIPTION OF THE DRAWINGS

FIG. 1 is a diagram for illustrating a sound/video generation system according to an embodiment of this invention.

FIG. 2 is a diagram for illustrating a schematic configuration of the entire sound/video generation system according to the embodiment of this invention.

FIG. 3 is a diagram for illustrating a schematic configuration of the mobile terminal according to the embodiment of this invention.

FIG. 4 is a diagram for illustrating an exemplary appearance of the mobile terminal including a motion detection unit.

FIG. 5 is a diagram for illustrating a schematic configuration of the dongle, which is a component of the sound/video generator.

FIG. 6 is a diagram for illustrating an exemplary appearance of the dongle.

FIG. 7 is a diagram for illustrating an example of two dancers wearing the mobile terminals on both arms and both legs.

FIG. 8A is a diagram for illustrating an example of switching between sound groups.

FIG. 8B is a diagram for illustrating an example of switching between sound groups and video groups.

FIG. 9 is a diagram for illustrating plotted values in the X direction, the Y direction, and the Z direction when a three-dimensional acceleration sensor is fixed to an arm and the dancer hits up or down ten times.

FIG. 10 is a diagram for illustrating plotted values calculated by Expression (1) from X direction, the Y direction, and the Z direction component values of the three-dimensional acceleration sensor.

FIG. 11 is a diagram for illustrating plotted values calculated by Expression (2) from X direction, the Y direction, and the Z direction component values of the three-dimensional acceleration sensor.

FIG. 12 is a diagram for illustrating plotted values in the X direction, the Y direction, and the Z direction when a three-dimensional gyro sensor is fixed to an arm and the arm is swung up and down.

FIG. 13 is a diagram for illustrating plotted values calculated by Expression (1) from X direction, the Y direction, and the Z direction component values of the three-dimensional gyro sensor.

FIG. 14 is a diagram for illustrating plotted values calculated by Expression (2) from X direction, the Y direction, and the Z direction component values of the three-dimensional gyro sensor.

FIG. 15 is a diagram for illustrating basic processing flowchart of the CPU in the mobile terminal including motion detection unit.

FIG. 16 is a diagram for illustrating another example of detection by the three-dimensional acceleration sensor.

### DETAILED DESCRIPTION OF THE PREFERRED EMBODIMENTS

Now, a description is given of how to solve the above-mentioned problems and achieve the object. First, a three-dimensional acceleration sensor is taken as an example for description. A simpler method is used to determine presence or absence of a motion without employing the related-art determination method in the following manner as an example:

thrusting motion when ax<az and ay<az;

swinging motion when az<ax and az<ay;

horizontal swinging motion when az<ax, az<ay, and ax<ay; and

vertical swinging motion when az<ax, az<ay, and ay<ax,

where the accelerations in three orthogonal axes (X axis, Y axis, Z axis) are represented by ax, ay, and az, respectively. The three axes are desired to be orthogonal to one another, but it suffices that motions in different directions can be detected in a distinctive manner based on those three axes. In other words, it suffices that a combination of axis directions is set such that any motion by a dancer can be detected based on any one of those axes.

Further, in order to solve another problem, there is prepared means for causing an individual mobile terminal including a motion detection unit and fixed to a motion subject to move to confirm a detection level threshold value and storing the detection level threshold value into the mobile terminal.

In the related art, a mobile terminal including a motion detection unit is configured to transmit all the information of a motion detection sensor (e.g., acceleration, angular velocity, and geomagnetic value) to a sound/video generator, and a calculation unit in the sound/video generator is configured to perform determination of the information. However, for example, when a large number of dancers each wear mobile terminals including motion detection unit on both arms and both legs, and transmit motion detection sensor information all at once, the calculation unit in the sound/video generator cannot handle the processing.

In view of this, an embodiment of this invention is configured such that each mobile terminal including a motion detection unit determines whether or not a detection level threshold value is exceeded, transmits the determination result to a sound/video generator, and the sound/video generator generates a preset (or random) sound in accordance with an instruction. In order to implement this configuration, there are prepared hardware and firmware for the mobile terminal including a motion detection unit to independently determine whether or not the detection level threshold value is exceeded.

Further, in order to reduce loads of calculation processing on the sound/video generator, another embodiment of this invention may be configured such that each mobile terminal individually performs calculation processing and transmits only the calculation result to the sound/video generator, and a calculation unit in the sound/video generator determines whether or not each detection level threshold value is exceeded.

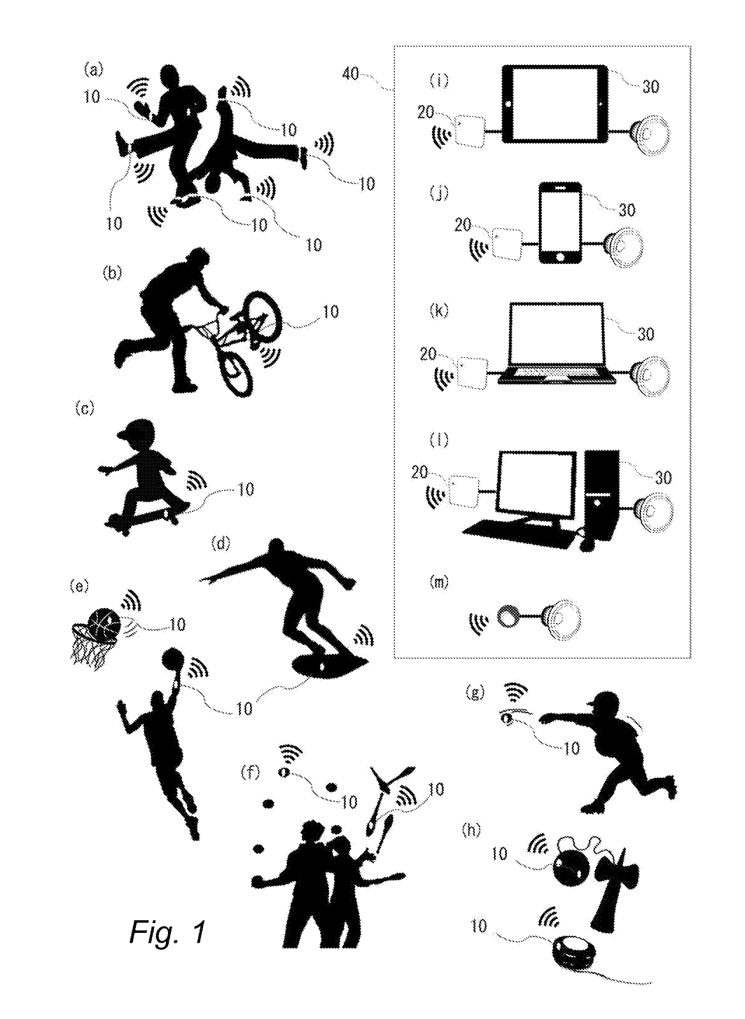

FIG. 1 is a diagram for illustrating a sound/video generation system according to the embodiment of this invention. The sound/video generation system includes a sound/video generator 40 and a mobile terminal 10 including a motion detection unit. The sound/video generation system is implemented by various combinations of application examples illustrated in FIG. 1(a) to FIG. 1(h) and sound/video generators illustrated in FIG. 1(i) to FIG. 1(m) .

[Examples of Wearing Mobile Terminal Including Motion Detection Unit]

FIG. 1(a) illustrates an application example in which a dancer wears the mobile terminals 10. The dancer wears the mobile terminals 10 on both wrists and both ankles. The wearing position is not particularly limited, and may be a hip, for example. Dancing is generally performed with music, but in this invention, the dancer can produce a sound by his or her performance without music. Music and the sound produced by the dancer may be played in collaboration. With this, it is possible to realize more active dancing and improve artistic quality.

FIG. 1(b) illustrates an application example of bicycle motocross (BMX). Sound effects may be generated by performance such as jumping or turning, or at the time of transition of performance. With this, it is possible to attract attention of the audience. Similarly, this example may be applied to racing using a motocross bicycle or acrobatic performance, for example, rotation in the air.

FIG. 1(c) illustrates an example of fixing the mobile terminal 10 to a skateboard. Sound effects are generated at the time of, for example, jumping in the air, landing, or stopping by applying a brake. With this, it is possible to attract attention of the audience.

FIG. 1(d) illustrates an application example of surfing. Sound effects are generated at the time of, for example, successfully getting into a wave, rotating, or getting out of a wave. With this, it is possible to attract attention of the audience watching on a beach to the skills.

Further, in this invention, a cooperator on the beach can adjust a level for determining whether “to generate a sound” or “not to generate a sound”. Thus, sound effects can be adjusted finely not to be generated unintentionally depending on a day of large waves or small waves.

It is not preferred to directly adjust the level using the mobile terminal 10 in salty seawater considering that the mobile terminal 10 is an electronic product, and it is also not practical to surf with a surfboard that has installed a sound/video generator. Similarly, it is possible to attract attention of the audience in a competition on snow, for example, half-pipe snowboarding with sound effects.

FIG. 1(e) illustrates an application example of basketball. When a player wears the mobile terminal 10 on his or her arm, sound effects that excite the audience can be generated when the player raises his or her arm just before shooting. In other cases, in a case where a ball has incorporated therein the mobile terminal 10, “rolling” sound effects can be generated when the ball is rolling around the goal ring, or “swish” sound effects can be generated when the ball goes through the basket without touching the rim or backboard, to thereby entertain the audience. In freestyle basketball, sound effects can be generated when the ball spins or bounces, to thereby attract attention of the audience walking along a street. For example, in the case of soccer ball lifting, sound effects are generated when the ball is kicked or depending on the height of the kicked ball. Further, soccer ball lifting may be counted such that the sound/video generation system generates the sound of one, two, three, and on and on, to thereby improve game quality.

FIG. 1(f) illustrates an application example of juggling. The ball or club has the built-in mobile terminal 10 including a motion detection unit, and generates sound effects depending on shock, rotation, and height of the ball or club, which is interesting.

FIG. 1(g) illustrates an application example of baseball. The ball has the built-in mobile terminal 10 including a motion detection unit, and changes sound tone depending on the pitch speed, the number of spins, and the spin direction. The audience is more entertained by, for example, generating sound effects of a fast ball even when a slow ball is thrown, or generating sound effects of when a heavy 150-km/h ball like that of a professional baseball player is caught with a mitt depending on the impact of catching the ball. Further, whether the spin is right spin, left spin, vertical spin, or other spin can be identified based on the sound, and thus it is possible to reflect on the practice of throwing breaking balls. Further, an actual pitch speed can be measured with an installed sensor, which improves utility of the ball.

FIG. 1(h) illustrates an application example of a toy. When the toy is a kendama (Japanese ball and cup game), the ball has incorporated therein the mobile terminal 10. The kendama can be played in a manner unique to a toy by, for example, generating a spinning sound when the ball jumps into the air, or generating a fanfare sound when the ball is successfully caught on the cup. Similarly, when the toy is a yo-yo, the sound effects can be enjoyed.

[Examples of Sound/Video Generator]

The sound/video generator 40 is provided in the form of, for example, a tablet computer as illustrated in FIG. 1(i), a smartphone as illustrated in FIG. 1(j), a laptop computer as illustrated in FIG. 1(k), or a desktop computer as illustrated in FIG. 1(l), which is a host computer 30, or a dedicated machine as illustrated in FIG. 1(m).

When the device illustrated in FIG. 1(i) to FIG. 1(l) does not have an internal circuit for communicating to/from the mobile terminal 10 including a motion detection unit for transmission/reception of data (dedicated machine illustrated in FIG. 1(m) has internal communication circuit), the device illustrated in FIG. 1(i) to FIG. 1(l) uses an external transceiver circuit 20 (hereinafter referred to as “dongle 20”), which is coupled to the host computer illustrated in FIG. 1(i) to FIG. 1(l) via, for example, a Universal Serial Bus (USB) connector or a micro USB connector.

When the volume of a speaker incorporated in the host computer illustrated in FIG. 1(i) to FIG. 1(m) is small, an external speaker or an amplified speaker is used as illustrated in FIG. 1(i) to FIG. 1(m).

[Configuration of Entire System]

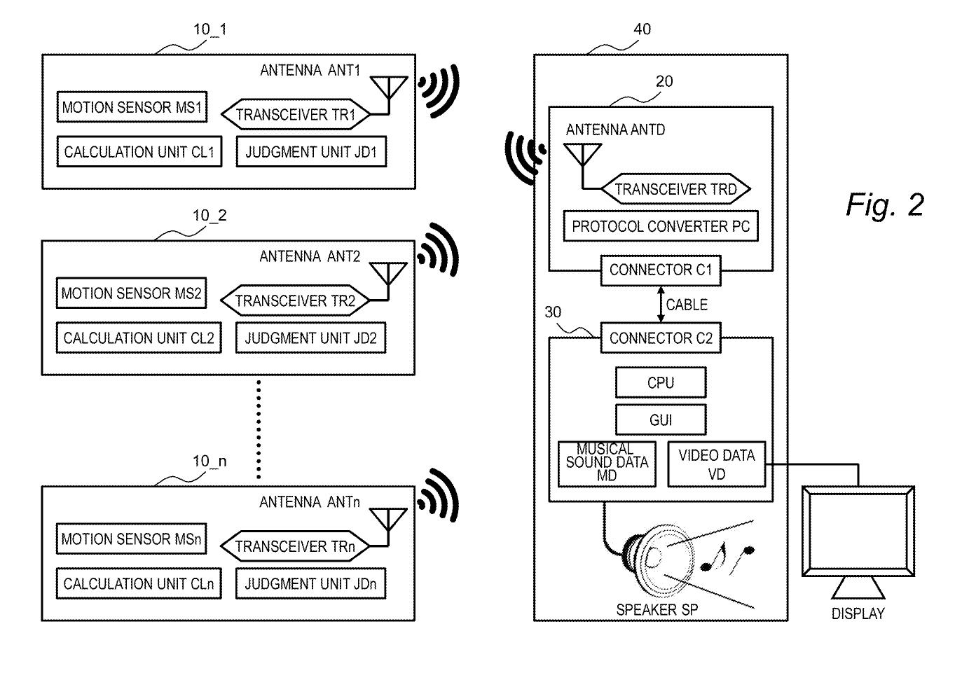

FIG. 2 is a diagram for illustrating a schematic configuration of the entire sound/video generation system according to the embodiment of this invention.

There are n mobile terminals 10 including motion detection unit, and one sound/video generator 30 is configured to reproduce a sound set in advance in the n terminals. The sound may be reproduced randomly depending on the concept of a product.

A mobile terminal 10_n includes a motion sensor MSn, a calculation unit CLn, a judgment unit JDn, and a transceiver TRVn, and is configured to communicate to/from the dongle 20 constructing the sound/video generator 40 via an antenna ANTn. The other mobile terminals 10_1 and on and on have the same configuration. The wireless communication is performed via Wi-Fi, Bluetooth, or ZigBee or via other wireless communication standards. When the sound/video generator 40 has an internal wireless communication unit of those types, the dongle 20 may be omitted.

In the embodiment of this invention, ZigBee or Bluetooth, which has a highly responsive connection, is employed in consideration of a period of time from sensation of a motion by the motion sensor MSn in the mobile terminal 10_n until generation of a sound by the sound/video generator 40.

The dongle 20 includes an antenna ANTD, a transceiver TRD, and a protocol converter PC, and is coupled to the host computer 30 in the sound/video generator 40 via connectors C1 and C2. In general, a USB connection is used, and thus the interface of the dongle 20 is a USB interface.

The host computer 30 includes a calculation unit CPU and a graphic user interface (GUI), and a user uses those components to, for example, assign a sound to each mobile terminal 10_n. A storage unit (not shown) in the host computer stores musical sound data MD and video data VD. The video data VD may be moving image data or still image data.

When an instruction to generate a sound/video reaches the host computer 30 from each mobile terminal 10_n via the path described above, the host computer 30 uses the GUI to generate a sound set in advance from a speaker (not shown) in the host computer, an external speaker SP, or an amplified speaker SP.

When an instruction to generate a video reaches the host computer 30 from each mobile terminal 10_n via the path described above, the host computer 30 uses the GUI to generate a video set in advance from a display of the host computer, an external display, or a projector (not shown).

Whether to set a sound or a video in advance or to select a sound or a video randomly depends on the concept of a product. Further, both of a sound and a video may be associated with the motion of a dancer, or one of a sound and a video may be associated with the motion of a dancer. When a motion of hands of a dancer is detected, a sound may be generated, while when a motion of legs is detected, a video may be generated. In other cases, when a motion of a right hand or a right leg is detected, a sound may be generated, while when a motion of a left hand or a left leg is detected, a video may be generated.

As described above, when the user adjusts a threshold value of the motion detection level, the user uses the GUI of the host computer to change the threshold value and check whether or not a sound is actually generated while moving the subject mobile terminal 10_n.

In this case, the threshold value data flows through the connector C2 of the host computer and the connector C1 of the dongle 20, passes through the transceiver TRD in the dongle 20, and is transmitted as radio waves through the antenna ANTD.

The subject mobile terminal 10_n has an individual identification number, and thus the transceiver TRVn of the mobile terminal 10_n, which has recognized that the threshold value data is addressed to the mobile terminal 10_n, receives the threshold value data. Then, the threshold value of the motion detection level to be used by the judgment unit JDn is stored as a comparison value (not shown).

[Configuration of Mobile Terminal Including Motion Detection Unit]

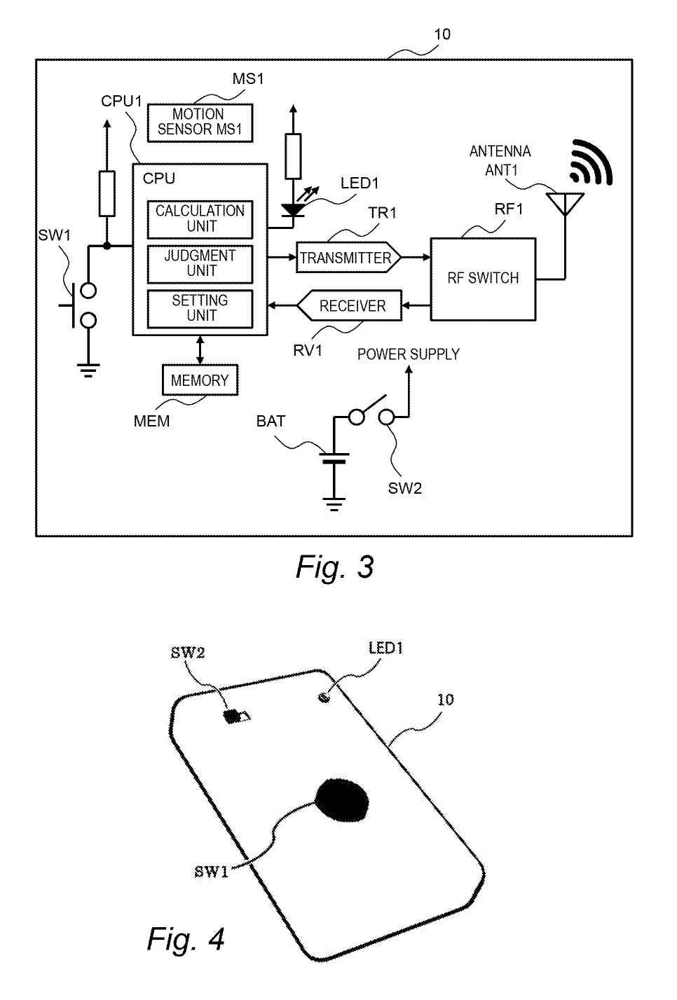

FIG. 3 is a diagram for illustrating a schematic configuration of the mobile terminal 10 including a motion detection unit according to the embodiment of this invention.

As described above, in this invention, the mobile terminal voluntarily performs comparison with the threshold value of the motion detection level, and instructs generation of a sound. Therefore, a CPU1 for performing calculation processing is required.

The threshold value of the motion detection level determined in the procedure described above is stored by a setting unit of the CPU1 into an internal or external memory MEM of the CPU. The judgment unit of the CPU1 causes the calculation unit to perform predetermined calculation based on data obtained from a motion sensor MS1, compares the calculated value with the threshold value of the motion detection level stored in the memory MEM, and determines whether “to generate a sound” or “not to generate a sound”.

When the judgment unit of the CPU1 determines to generate a sound, the judgment unit constructs a data sequence in accordance with the used wireless communication protocol, switches an RF switch RF1 to an output mode, and transmits the data sequence through an antenna ANT1 via a transmitter TR1.

Further, as described above, the calculation unit of the CPU1 may perform the predetermined calculation and transmit only the result to the host computer 30 of the sound/video generator 40, and the CPU of the host computer 30 may compare the calculated value with a predetermined threshold value to determine whether “to generate a sound” or “not to generate a sound”.

The RF switch RF1 is switched to an input mode other than when transmission is performed, and inputs a data sequence from the antenna ANT1 to the CPU1 via a receiver RV1 in accordance with the used wireless communication protocol. The CPU1 constantly monitors the data sequence for its individual identification number, and when the individual identification number matches the own individual identification number, the CPU1 understands that a new threshold value of the motion detection level is transmitted from the dongle 20 of the sound/video generator 40, and stores the threshold value into the external or internal memory MEM of the CPU with the setting unit of the CPU1.

As described above, the motion sensor MS1 is, for example, an acceleration sensor, a gyro sensor, or a geomagnetic sensor, and a single or a plurality of types of sensors are mounted depending on the concept of a product. There are various types of motion sensors such as a one-dimensional (X direction) motion sensor, a two-dimensional (X direction, Y direction) motion sensor, and a three-dimensional (X direction, Y direction, Z direction) motion sensor. Among those sensors, three-dimensional motion sensors are now widely used at inexpensive prices, and thus it is necessary and sufficient to give a description based only on the three-dimensional motion sensor.

A commission switch SW1 is configured to pair the mobile terminal 10_n with the host computer in the sound/video generator 30. With this, the individual identification number of the mobile terminal 10 n is stored in the host computer, and the user can use the GUI of the host computer 30 to set, for example, which sound is to be generated or what value is set to the threshold value of the motion detection level.

An LED1 is a display configured to light up to allow the user to check operations when the data sequence is transmitted/received. As illustrated in FIG. 1A to FIG. 1H, the mobile terminal 10_n is fixed to various places, and thus needs to be driven by a battery. A power switch SW2 is configured to allow supply of power to each circuit.

The battery to be used differs depending on the concept of a product. When a rechargeable battery is used, the mobile terminal 10_n may include a charging circuit depending on the concept of a product (not shown).

FIG. 4 is a diagram for illustrating an exemplary appearance of the mobile terminal 10 including a motion detection unit. The commission switch SW1, the power switch SW2, and the communication monitor display LED1 at the time of transmission/reception are illustrated.

[Configuration of Dongle]

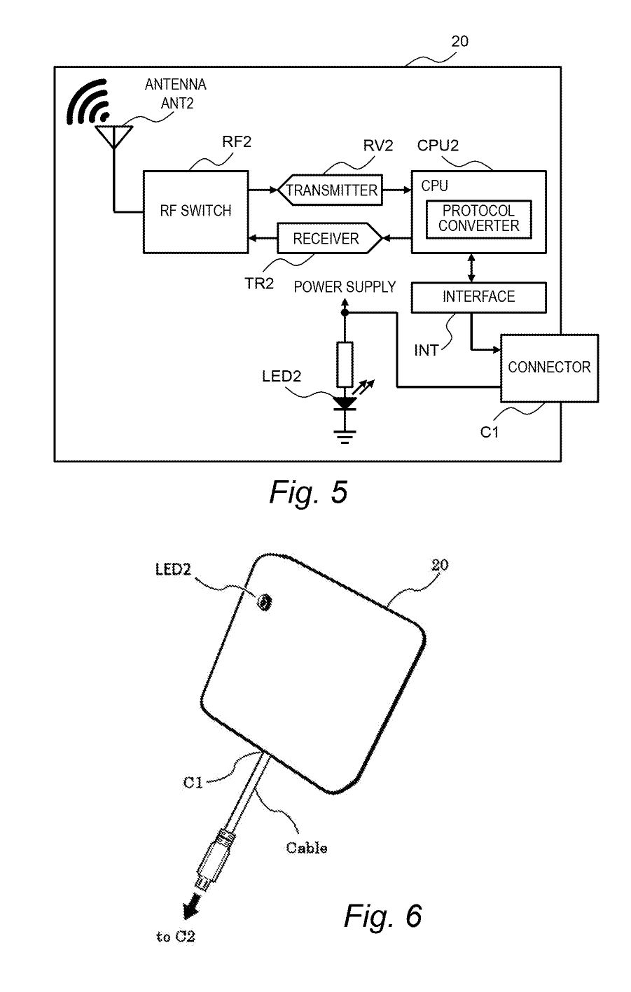

FIG. 5 is a diagram for illustrating a schematic configuration of the dongle 20, which is a component of the sound/video generator 40.

As described above, a USB connector is generally used as the connector C1. The USB standard allows one connector to acquire 5-volt and 500-milliampere power supply from the host computer, which is sufficient to cover total power consumption of the dongle 20. Power is acquired directly through the connector C1 and supplied to each component of the dongle. A power switch is not provided because the dongle is required only when the host computer is in operation.

An LED2 is provided to indicate a state in which power is being supplied.

The data sequence flowing from the host computer is constructed in accordance with the USB protocol. The data sequence passes through a USB interface INT via a USB cable, and then is passed to a CPU2. The dongle 20 has the role of converting the data sequence into one that is based on the used radio communication protocol.

In other words, depending on whether to transmit or receive data, the CPU2 uses the protocol converter to convert USB protocol data into radio communication protocol data at the time of transmission, or convert radio communication protocol data into USB protocol data at the time of reception.

Operations of an antenna ANT2, an RF switch RF2, a receiver RV2, and a transmitter TR2 are similar to corresponding ones described above, and thus a description thereof is omitted here.

FIG. 6 is a diagram for illustrating an exemplary appearance of the dongle 20.

The dongle 20 includes the power supply indication LED2, the connector C1 (not shown in FIG. 6), and a cable.

[Further Application Example]

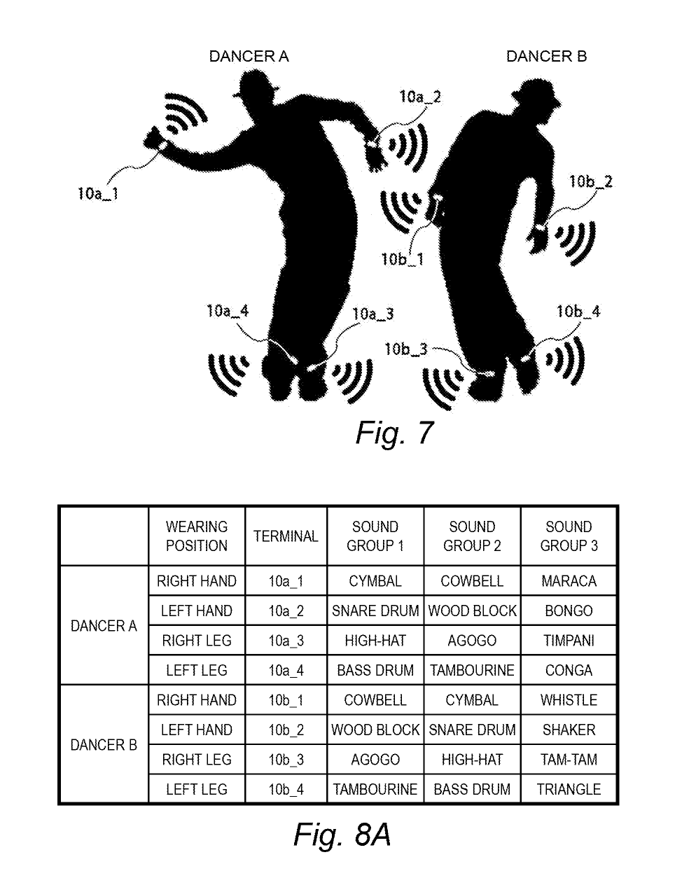

FIG. 7 is a diagram for illustrating an example of two dancers wearing the mobile terminals 10 including motion detection unit on both arms and both legs. In this case, the individual identification numbers of the eight mobile terminals 10 are stored in the host computer 30 in the sound/video generator 40 by the above-mentioned method, and the user uses the GUI of the host computer 30 to set, for example, which sound is to be generated or what value is set to the threshold value of the motion detection level.

Now, an example of replacing the motion sensor MS1 of FIG. 3 with a simple switch is described. This switch is referred to as “sound/video switcher”. This sound/video switcher is apparently similar to the mobile terminal including a motion detection unit, but at most one bit of the data sequence that is based on the wireless communication protocol may be used to distinguish between the mobile terminal and the sound/video switcher.

The sound/video switcher may be paired with the host computer 30 using the same procedure as that of storing the individual identification number of the mobile terminal 10_n into the host computer. In other words, the individual identification number of the sound/video switcher is stored into the host computer via a commission switch, and at most one bit of the data sequence that is based on the wireless communication protocol is used to recognize the sound/video switcher.

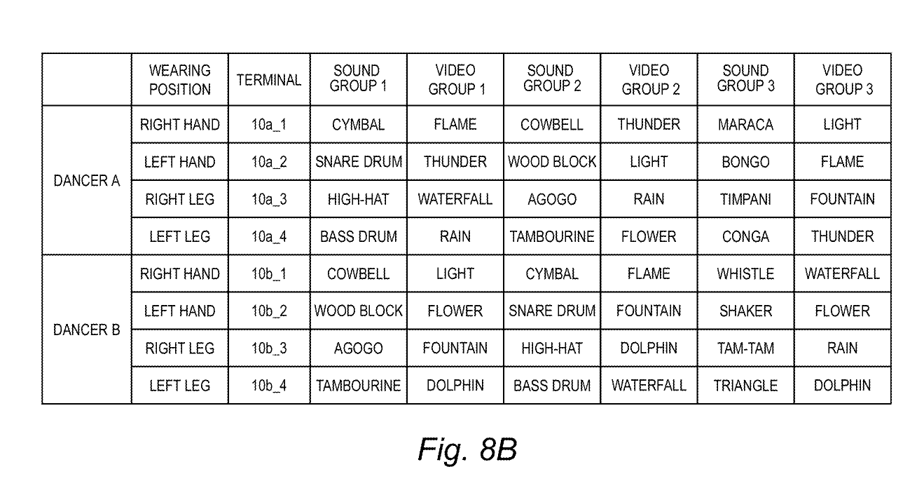

FIG. 8A is a diagram for illustrating an example of switching between sound groups. This is an application example in which, every time a switch of the sound/video switcher is pressed, a sound group 1 switches to a sound group 2, then to a sound group 3, then to the sound group 1 again, and on and on. The dancer switches between the sound groups by stepping on the switch of the sound/video switcher set on the floor or the ground. The dancer can show a wide variety of performances with the sound/video switcher. In the example of FIG. 8A, the sound group 1 is switched to the sound group 2 so that sounds of a dancer A and a dancer B are switched therebetween smoothly.

FIG. 8B is a diagram for illustrating an example of switching between sound groups and video groups. This is an application example in which, every time the switch of the sound/video switcher is pressed, a sound group 1 and a video group 1 switch to a sound group 2 and a video group 2, then to a sound group 3 and a video group 3, then to the sound group 1 and the video group 1 again, and on and on. The dancer switches between the sound and video groups by stepping on the switch of the sound/video switcher set on the floor or the ground. The dancer can show a wide variety of performances with videos and sounds with the sound/video switcher. In the example of FIG. 8B, although sounds of the dancer A and the dancer B are switched therebetween by switching the sound group 1 to the sound group 2, the videos are not switched therebetween and switched to other videos.

The example of switching sounds and the example of switching sounds and videos have been described with reference to FIG. 8A and FIG. 8B, respectively, but only the videos may be switched in the sound/video generation system according to this embodiment.

There are many ways of switching sounds depending on the concept of an application software product to be executed by the host computer 30 in the sound/video generator 40. For example, in an example in which sounds of the dancer A and the dancer B are switched therebetween every time the sound/video switcher is pressed, when a story-like dance is constructed such that the dancer A plays the role of an attacking side and the dancer B plays the role of a defending side, the dancer A or the dancer B can operate the switch of the sound/video switcher set on the floor (for example, by stepping on the switch) to quickly change roles of the attacking side and the defending side. Further, for example, the set sound of each mobile terminal may be switched every time the switch is operated when the dancer A points to the dancer B, which is interesting.

The sound/video switcher is not necessarily one, and sound/video switchers may be prepared separately for the dancers A and B.

[Motion Detection Calculation Method Using Motion Sensor Data]

According to this invention, the mobile terminal 10 includes a calculation unit configured to add magnitudes of motion sensor data.

Now, a description is given using an example of the acceleration sensor. In the related-art method of giving importance to acceleration components in the X direction, the Y direction, and the Z direction, an absolute acceleration, namely, an absolute value |α| of the acceleration is first calculated in accordance with the following expression.

|α|=\sqrt{αx²+αy²+αz²} (1)

It is known that analysis of a human motion in the X direction, the Y direction, and the Z direction results in a complicated motion waveform containing many pseudo peaks. Thus, it is necessary to pass the absolute acceleration calculated in accordance with Expression (1) through, for example, a 12-th order moving average digital filter in order to remove unnecessary high frequency components from the absolute acceleration.

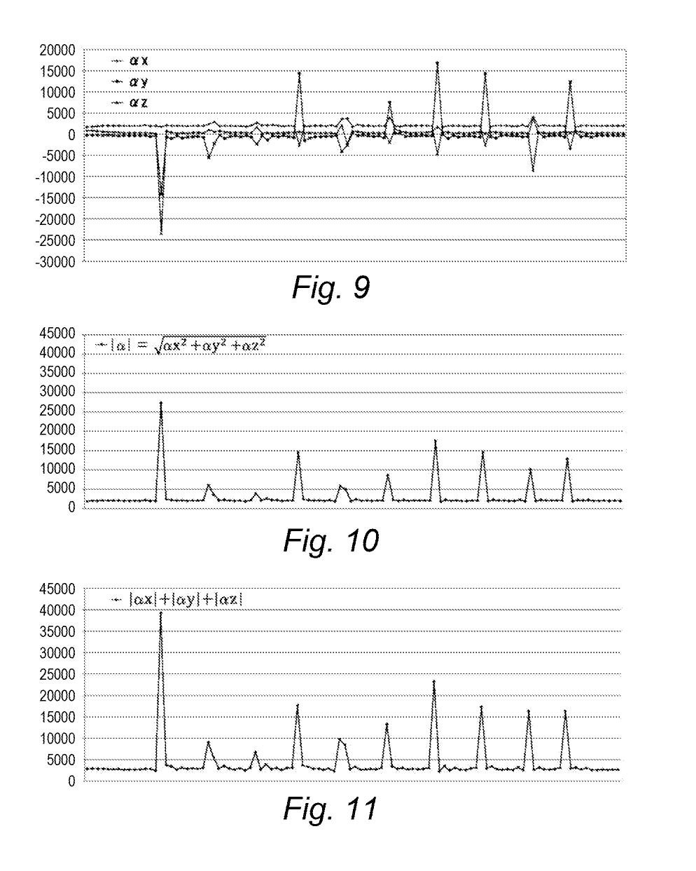

FIG. 9 is a diagram for illustrating plotted values in the X direction, the Y direction, and the Z direction when a three-dimensional acceleration sensor is fixed to an arm and the dancer hits up or down ten times.

Values in the vertical axis represent gravitational accelerations in milligrams (mg). The time interval between plotted points is equivalent to one round of the main loop of microcomputer software used for measurement. In other words, the value of the three-dimensional acceleration sensor is read once in the main loop. The part that plunges on the left side is a case where the dancer hits his or her arm down strongly, and it is understood that the subsequent values are fluctuating like down, down, up, and on and on.

FIG. 10 is a diagram for illustrating plotted values calculated by Expression (1) using component values of FIG. 9. FIG. 11 is a diagram for illustrating plotted values calculated by Expression (2), which is employed in this invention.

|αx|+|αy|+|αz| (2)

Through comparison between FIG. 10 and FIG. 11, it can be said that FIG. 10 is a relatively moderate graph, whereas FIG. 11 has a larger variation with distinctive changes. However, there is no significant difference in graph waveform between FIG. 10 and FIG. 11 other than the variation.

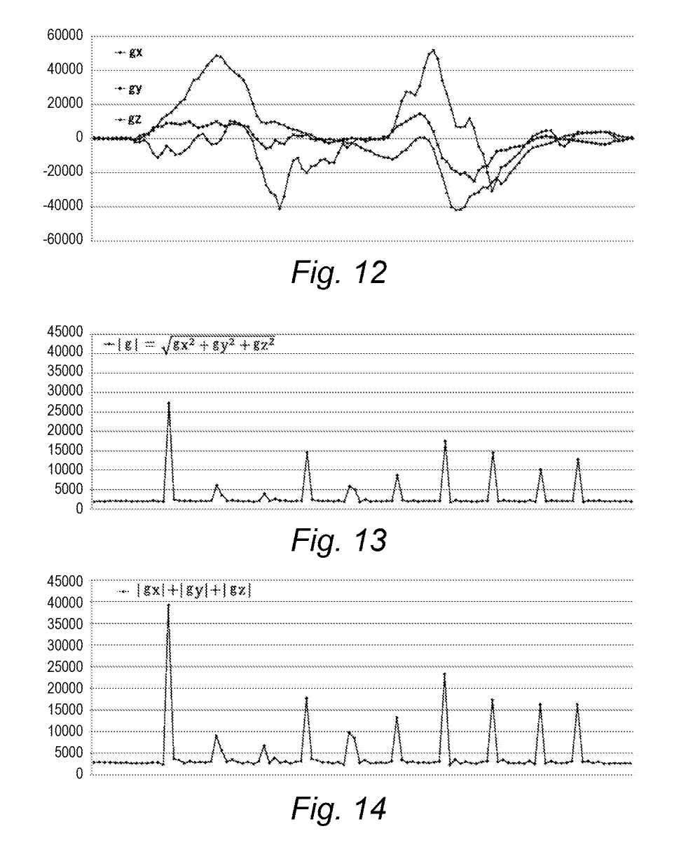

FIG. 12 is a diagram for illustrating plotted values in the X direction, the Y direction, and the Z direction when a three-dimensional gyro sensor is fixed to an arm and the arm is swung up and down.

Values in the vertical axis represent degrees per second (dps). As in the above-mentioned graphs, the time interval between plotted points is equivalent to one round of the main loop of the microcomputer software used for the measurement. It is understood that the Z component especially fluctuates greatly.

FIG. 13 is a diagram for illustrating plotted values calculated by Expression (1) using component values of FIG. 12. FIG. 14 is a diagram for illustrating plotted values based on a calculation result of Expression (2), which is employed in this invention.

Through comparison between FIG. 13 and FIG. 14, it can be said that FIG. 13 is a relatively moderate graph having a smaller variation, whereas FIG. 14 has a larger variation with distinctive changes. However, there is no significant difference in graph waveform between FIG. 13 and FIG. 14 other than the variation.

When an actual experiment is performed as described above, and the calculation results are formed into graphs, it is understood that necessary data is obtained by simply adding absolute values without calculating, for example, complicated square roots or squares necessitating a multiplier.

In the application example in which the plurality of mobile terminals 10 including motion detection unit are used as illustrated in FIG. 1A, the mobile terminal is required to have an inexpensive market price. As described above, it is necessary to pass the absolute acceleration, which is obtained by calculating squares and square roots in accordance with Expression (1), through, for example, a 12-th order moving average digital filter in order to remove unnecessary high frequency components from the absolute acceleration.

An expensive microcomputer capable of calculating complicated square roots and multiplication needs to be adopted as the CPU1 of FIG. 3 in order for the mobile terminal 10 to execute Expression (1). This prevents mobile terminals from being provided to the market at inexpensive prices as described above.

When the host computer 30 of FIG. 2 is configured to calculate complicated square roots and multiplication, as described above, the mobile terminal 10 including a motion detection unit is configured to transmit all the motion detection sensor information (e.g., acceleration, angular velocity, and geomagnetic value) to the sound/video generator. In such a configuration, when a large number of dancers each wear mobile terminals including motion detection unit on both arms and both legs, and transmit motion detection sensor information all at once, the calculation unit in the sound/video generator cannot handle the processing.

Thus, as described in this invention, Expression (2), which can be implemented only by addition, is used without using Expression (1), which involves calculation of complicated square roots and multiplication and is based on a high-order digital filter. Then, each mobile terminal determines whether or not the detection level threshold value is exceeded and transmits only the determination result to the sound/video generator 40, or transmits data on the added value itself to the sound/video generator 40 and the host computer 30 in the sound/video generator 40 determines whether or not the detection level threshold value is exceeded. The host computer 30 generates a preset (or random) sound in accordance with an instruction.

According to this invention, a microcomputer of a few generations ago, which is extremely inexpensive and has a small number of bits, can be used as the CPU1 of FIG. 3, and thus mobile terminals can be provided to the market at inexpensive prices.

In summary, floating-point calculation is necessary to execute calculation of square roots and squares, and in addition, when a 12-th order digital filter needs to be prepared, an expensive 32-bit microcomputer is required. This means that it is difficult to provide mobile terminals to users at inexpensive prices. On the contrary, this invention requires simple addition of integers and magnitude comparison of integers, and thus an extremely inexpensive 8-bit microcomputer of about four generations ago is sufficient. With this invention, it is possible to provide inexpensive mobile terminals to users.

In the case of the related art in which a mobile terminal does not perform the above-mentioned floating-point calculation and the host computer of the sound/video generator performs the above-mentioned calculation, for example, values itself of a three-dimensional acceleration sensor of the mobile terminal in the X direction, the Y direction, and the Z direction are transmitted. However, in such a configuration, when a large number of mobile terminals transmit data all at once, the amount of required processing becomes too much for the host computer to handle, and various kinds of failures such as intermittent generation of a sound and delayed generation occur. This invention can solve such a problem.

[Specific Configuration of Mobile Terminal Including Motion Detection Unit]

The mobile terminal 10 including a motion detection unit needs to be driven by a battery as described above. Suppression of power consumption is important to increase the operable time of the mobile terminal driven by a battery.

It is widely known that a radio wave transceiver consumes a large amount of power in the mobile terminal in general. Thus, it is possible to suppress total power consumption by turning off power when the radio wave transceiver is not used (standby mode) and turning on power when necessary.

As a more specific configuration, the mobile terminal including a motion detection unit uses an integrated unit XB including the transmitter TR1, the receiver RV1, the RF switch RF1, and the antenna ANT1 as one unit. When the integrated unit XB is used, the mobile terminal 10 includes, as its three main parts, the motion sensor MS1, the CPU1, and the integrated unit XB.

[Basic Operation of CPU in Mobile Terminal]

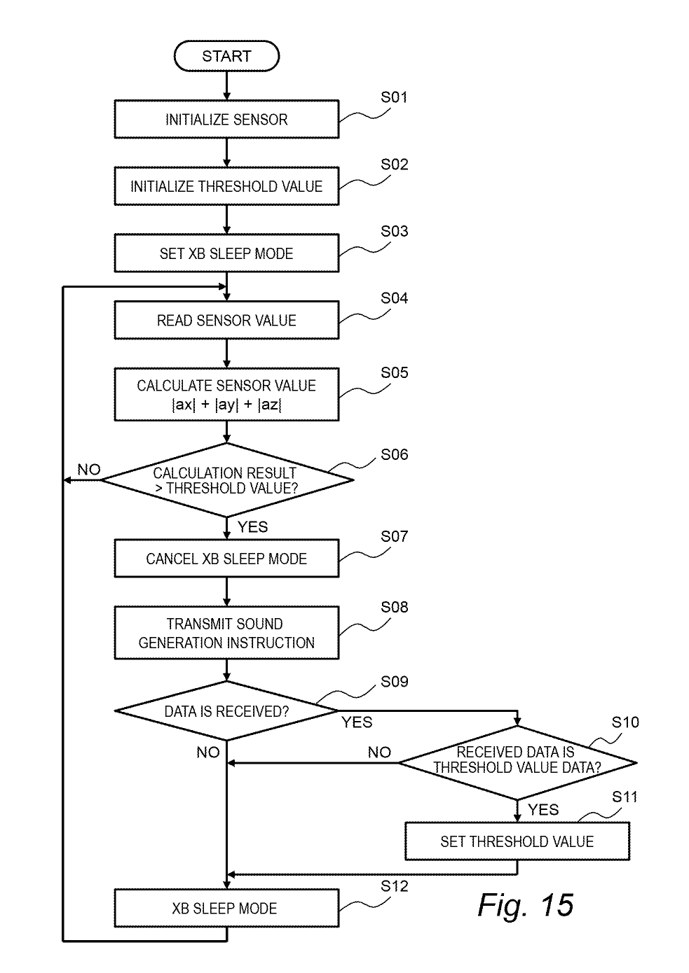

FIG. 15 is a diagram for illustrating basic processing flowchart of the CPU1 in the mobile terminal 10 with a threshold value. When the power switch SW2 of FIG. 3 and FIG. 4 is turned on, the CPU1 starts to operate and perform processing in accordance with the order illustrated in the flowchart of FIG. 15.

First, the CPU1 initially sets the motion sensor MS1 (Step S01) and the threshold value of the motion detection level (Step S02), and sets the integrated unit XB to a standby mode (Step S03), to complete the initial setting.

After the initial setting, the CPU1 enters the main loop to perform a series of processing. Now, an example of mounting a three-dimensional acceleration sensor is described.

First, the CPU1 reads values of the three-dimensional acceleration sensor MS1 in the X direction, the Y direction, and the Z direction (Step S04). After that, the calculation unit calculates Expression (2) (Step S05), and the judgment unit compares the calculation result with the threshold value of the motion detection level (Step S06).

When the judgment unit has determined that the calculation result exceeds the threshold value, the CPU1 cancels the standby mode of the integrated unit XB (Step S07), and the integrated unit XB transmits an instruction to generate a sound/video (Step S08). At the same time as transmission, the integrated unit XB receives data from the host computer 30 in the sound/video generator 40. When the integrated unit XB receives data (Step S09), and the received data is threshold value data (Step S10), the setting unit stores new threshold value data into the memory MEM of FIG. 3 (Step S11). After that, the setting unit again sets the integrated unit XB to the standby mode to save power (Step S12), and returns to again the step of reading values of the three-dimensional acceleration sensor MS1 (Step S04). In this manner, the main loop is formed.

[Registration Processing]

As described above, registration processing is started by pressing the commission switch SW1. When the CPU1 recognizes that the commission switch SW1 is pressed, the CPU1 inserts the individual identification number of the mobile terminal 10 into the data sequence that is based on the used wireless communication protocol, and transmits the data sequence to the sound/video generator 40. The host computer 30 in the sound/video generator 40 stores the individual identification number, and notifies the user of the fact with GUI display.

[Threshold Value Data Transmission/Reception Processing]

Threshold value data for determining whether to generate a sound/video is set by, for example, operation on the GUI of the host computer 30. The user operates the GUI screen to switch to a threshold value data setting screen, and determines the threshold value. The threshold value data is inserted into the data sequence that is based on the used wireless communication protocol together with the individual identification number of the subject mobile terminal, and input through the antenna ANTD of the dongle 20 of FIG. 2 and the antenna ANTn of the mobile terminal 10_n.

The mobile terminal 10 n checks whether or not the transmitted individual identification number is the same as the own individual identification number, and stores the threshold value into the external or internal memory MEM of the CPU with the setting unit of the CPU1.

[Sound/Video Generation Processing]

As described above, the calculation unit of the CPU1 of FIG. 3 performs predetermined calculation based on data obtained from the motion sensor MS1, and the judgment unit compares the calculated value with the threshold value of the motion detection level stored in the memory MEM, to thereby determine whether “to generate a sound” or “not to generate a sound”. When a video is reproduced, the judgment unit determines whether “to generate a video” or “not to generate a video”. The determination result is inserted into the data sequence that is based on the used wireless communication protocol together with the individual identification number, and is transmitted through the antenna ANT1.

The transmitted data is received by the dongle 20 of the sound/video generator 40 of FIG. 2, and is transmitted to the host computer 30 through the protocol converter PC. The host computer 30 checks whether or not a sound and a video are set to the transmitted individual identification number, and generates the corresponding sound and video.

As described above, the calculation unit of the CPU1 may perform predetermined calculation and transmit only the result to the host computer 30 of the sound/video generator 40, and the CPU of the host computer 30 may determine whether “to generate a sound” or “not to generate a sound”. When a video is reproduced, whether “to generate a video” or “not to generate a video” may be determined.

[Another Method of Calculating Motion Detection by Motion Sensor Data]

Next, another example of detecting an acceleration is described. In the embodiment described above, the human motion is detected by the sum of absolute values of acceleration values in three axes, but in a modification example described below, the human motion is detected by a variation amount of the acceleration.

Specifically, when components of accelerations in the X direction, the Y direction, and the Z direction are detected, a variation amount of the sum of absolute values of the accelerations ax, ay, and az is calculated for a predetermined period (e.g., 1 millisecond) using Expression (3) based on the output values of the three-axis acceleration sensor, and the calculated value is compared with a predetermined threshold value of the motion detection level, and when the variation amount of the sum of absolute values of the accelerations exceeds the predetermined threshold value, it is determined “to generate a sound”.

Δ(|ax|+|ay|+|az|) (3)

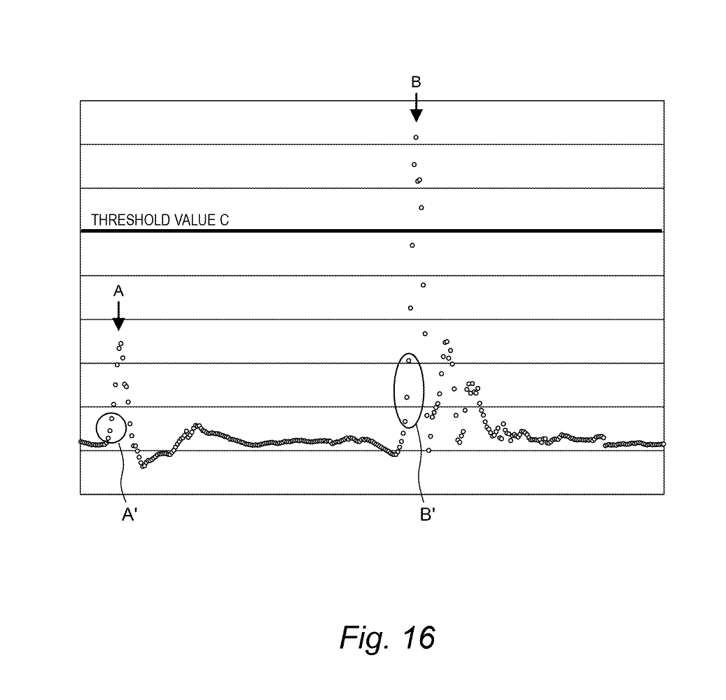

FIG. 16 is a diagram for illustrating a change in acceleration in the X-axis direction. As shown in FIG. 16, a peak B is higher than a peak A, and the peak B exceeds a threshold value C, whereas the peak A does not exceed the threshold value C. When rising portions of the peak A and the peak B are compared with each other, a rising part B′ of the peak B has a larger change in acceleration per unit time than a rising part A′ of the peak A. Thus, through comparison between the variation amount of the sum of absolute values of the accelerations for a predetermined period and the predetermined threshold value of the motion detection level, it can be determined “to generate a sound” at an early timing, and a sound and a video can be generated without much delay.

Further, when the variation amount of the acceleration is used, a composite value of accelerations in respective axes may be calculated as a square root of the sum of squares of the accelerations, and the composite value may be used to determine whether or not “to generate a sound”. Specifically, the variation amount of the composite value calculated in accordance with Expression (4) for a predetermined period (e.g., 1 millisecond) is compared with the predetermined threshold value of the motion detection level, and when the variation amount of the composite value of accelerations exceeds the predetermined threshold value, it is determined “to generate a sound”.

Δ\sqrt{ax²+ay²+az²} (4)

As described above, in this modification example, the variation amount of the acceleration is used to detect a motion for which to generate a sound even before the sum of absolute values of accelerations in three axes reaches the predetermined threshold value. Therefore, it is possible to generate a sound and a video without much delay.

This modification example is described using the acceleration, but the human motion may be detected by using the variation amount of, for example, an angular velocity and a geomagnetic value. Further, the timing of generating a video may be determined without determining the timing of generating a sound. The timing of generating a sound and the timing of generating a video may be determined at the same time.

As described above, according to the embodiment of this invention, data on a motion detected in three axes directions substantially orthogonal to one another is used to determine the motion of a motion subject (e.g., person). Thus, this invention and JP 2007-298598 A, which discloses calculation of a string action position using accelerations in two axes, solve different problems and have different technical ideas.

Further, according to the embodiment of this invention, the absolute values of magnitudes of data on a motion detected in three axes directions substantially orthogonal to one another are added to determine whether or not a predetermined amount of motion is detected. Thus, contrary to the related art, which uses the square root of the sum of squares of acceleration component values in the X direction, the Y direction, and the Z direction, this invention has a small calculation amount, and can process motions of a large number of motion subjects (e.g., person) without delay. Further, the variation amount of the value to be used for determination of a motion is large, and the threshold value can be set easily, to thereby reduce the risk of erroneous operations.

This invention is not limited to the embodiment described above and encompasses various modification examples. For example, the embodiment described above is a detailed description written for an easy understanding of this invention, and this invention is not necessarily limited to a configuration that includes all of the described components. The configuration of one embodiment may partially be replaced by the configuration of another embodiment. The configuration of one embodiment may be joined by the configuration of another embodiment. In each embodiment, a part of the configuration of the embodiment may have another configuration added thereto or removed therefrom, or may be replaced by another configuration.

For example, although the mobile terminal implements the judgment unit, the host computer (sound/video generator) may implement the judgment unit instead. In this case, the mobile terminal transmits the sum of components of the detected motion value (output of acceleration sensor) to the host computer, and the judgment unit of the host computer determines whether or not the calculation result exceeds the threshold value.

1. A sound/video generation system, comprising:
a mobile terminal including a motion detection unit and to be installed on a motion subject; and
a sound/video generator including a communication unit coupled to the mobile terminal in a wireless manner,
the mobile terminal including a calculation unit configured to add absolute values of magnitudes of data on a motion in directions of three axes substantially orthogonal to one another, which is detected by the motion detection unit,
the sound/video generation system comprising a judgment unit configured to determine whether or not a predetermined amount of motion is detected based on a result of calculation by the calculation unit,
the sound/video generator including a sound/video generation unit configured to generate at least one of a sound or a video in accordance with a result of determination by the judgment unit.

2. The sound/video generation system according to claim 1, wherein the judgment unit is configured to determine whether or not the predetermined amount of motion is detected based on whether or not a sum of absolute values of magnitudes of data on a motion, which is detected in terms of at least one of an acceleration, an angular velocity, and a geomagnetic value, exceeds a predetermined reference value.

3. The sound/video generation system according to claim 1, wherein the mobile terminal includes the judgment unit and a transmitter configured to transmit a result of determination by the judgment unit, and wherein the sound/video generator includes a receiver configured to receive the result of determination from the mobile terminal.

4. The sound/video generation system according to claim 3,
wherein the mobile terminal includes a setting unit configured to set a reference value for use in determination by the judgment unit, and
wherein the sound/video generator is configured to receive input of the reference value set by the setting unit, and transmit the reference value to the mobile terminal.

5. The sound/video generation system according to claim 4,
wherein the sound/video generation system includes the plurality of mobile terminals each being assigned with a piece of unique identification information,
wherein the transmitter is configured to transmit the piece of unique identification information together with the result of determination, and
wherein the sound/video generation unit is configured to generate a sound, which is set in association with the identification information, in accordance with the result of determination by the judgment unit.

6. The sound/video generation system according to claim 1, wherein the judgment unit is configured to determine whether or not the predetermined amount of motion is detected based on whether or not a variation amount of a sum of absolute values of data on a motion for a predetermined period, which is detected in terms of at least one of a detected acceleration, a detected angular velocity, or a detected geomagnetic value, exceeds a predetermined reference value.

7. The sound/video generation system according to claim 3,
wherein the sound/video generation system includes the plurality of mobile terminals each being assigned with a piece of unique identification information,
wherein the transmitter is configured to transmit the piece of unique identification information together with the result of determination, and
wherein the sound/video generation unit is configured to generate a sound, which is set in association with the identification information, in accordance with the result of determination by the judgment unit.
